(19) United States
(12) Patent Application Publication
(10) Pub. No.: US 2011/0284253 A1
(43) Pub. Date: Nov. 24, 2011

(54) DISC CULTIVATOR

(76) Inventor: Donald Stevenson, Saskatchawan (CA)

(21) Appl. No.: 12/784,919

(22) Filed: May 21, 2010

(51) Int. Cl. A01B 63/14; A01B 73/02

(52) U.S. Cl. 172/311; 172/423

(57) ABSTRACT

An agricultural cultivator having a set of cultivator discs followed by a packer roller, with the cultivator disc cutting depth and the packer roller pressure independently controllable during use. A disc cultivator with a frame adapted to be towed across a field, ground wheels supporting the frame, actuators for changing vertical position of the frame relative to the ground wheels, a cultivator disc assembly attached to the frame, the cultivator disc assembly having rotatable cultivator discs independently suspended from a cultivator disc support bar, a packer roller assembly attached to the frame rearward of the cultivator disc assembly, and actuators for changing vertical position of the packer roller assembly relative to the frame.

### FIELD OF THE INVENTION

The present invention relates to an agricultural implement for cultivating soil. In particular, the present invention relates to a compact disc cultivator of the type towed by a farm tractor or the like.

### BACKGROUND OF THE INVENTION

In the agricultural industry, cultivation of soil employs various styles of cultivators and harrows. In cooler climates the most common types are the disc cultivator (sometimes called a disc harrow), the chain harrow, the tine harrow or spike harrow and the spring tine harrow. Chain harrows are often used for lighter work such as leveling the tilth or covering seed, while disc cultivators are typically used for heavy work, such as following plowing to break up the sod. Tine harrows are used to refine seed-bed condition before planting, to remove small weeds in growing crops and to loosen the inter-row soils to allow for water to soak into the subsoil. All three types can be used in one pass to prepare the soil for seeding. It is also common to use any combination of two harrows for a variety of tilling processes. Where harrowing provides a very fine tilth, or the soil is very light so that it might easily be wind-blown, a roller is often added as the last of the set.

A compact disc cultivator is an implement used primarily to break up and smooth soil in preparation for planting and for the task of preparing soil for planting including tilling and leveling of fallow soil. The disc cultivators are effective at cutting into the soil and include a set of disc assemblies attached to a rigid frame supported on the ground by a set of ground wheels. Disc assemblies are generally equipped with a series of sharp metal discs set on edge or at an angle mounted to a common shaft. Disc cultivators generally have multiple gangs of disc assemblies located independently or in groups of two or more for turning and breaking the soil. The discs are generally arranged in a wide range of configurations designed to provide maximum soil disruption over as large an area as possible in a single pass. Even so, some earth remains unbroken, including large clumps or clods. It is known to use picks or breaker bars in combination with the disc assemblies to insure uniform earth disruption.

The Catros compact disc cultivator manufactured by AMAZONEN-WERKE H. Dreyer GmbH & Co., is a shallow soil working, intensive mixing soil tillage tool. The individual discs are supported via rubber sprung elements to allow for the optimum contouring and adaptation to the soil surface. Each disc is able to follow the ground contour. The working depth is always maintained and the shallow working in of plant residues protects the soil from erosion and capping. Critically, this cultivator cannot be easily varied in its cutting depth where the entire cultivator is supported by the packer-rollers on the trailing end of the frame without compromising the packer-roller pressure. This is especially true with a 3-point hitch pulling the cultivator because the packer-roller may be necessary to affect the cutting depth. It is possible with the Catros cultivator to raise and lower the roller, however the cutting depth of the discs is entirely dependent on the position of the rollers. For example, the maximum cutting depth can be achieved only by entirely raising the packer-rollers which is unacceptable in situations where the user requires both deep soil tillage and a packing of the soil.

Another cultivator product, Carrier made by Vaderstad includes a forward located height adjustment wheel set. Working depth is set hydraulically from the tractor cab and can be altered during work if required. This arrangement is similarly difficult to effectively control the cutting depth and packer pressure because the setting on the forward wheel height adjustment influences both the pressure roller at the back and the support wheels at the front. Again, the cutting depth and packer pressure cannot be independently controlled.

The company, Horshe, also manufactures a disc cultivator line called the “Joker DiscSystem” which similar to Vaderstad's, uses a front supporting wheel and a hydraulic system which controls both the disc packer-rollers and the cutting discs contemporaneously. Just as in the previously described machines, there is no way to independently vary the packing pressure on the packer-rollers and the cutting depth of the discs.

U.S. Pat. No. 7,188,680 discloses a cultivator which permits the operator to transfer weight i.e. tilt the frame from the front gang to the rear gang or from rear gang to front essentially to rotate about the field wheel axle of the cultivator. A hydraulic actuator extends and retracts to put more of the weight of the frame either on the front gang, or the rear gang. There is however no disclosure of an entirely independent packer pressure which is separate from the raising and lowering, or weight transferring actuators of the known cultivators.

A spike-toothed harrow uses rigid teeth instead of tines, for a more aggressive “bite” into hardened soils. Historically, spike-toothed harrows have consisted of a steel frame with lateral supports. Steel teeth on the lateral supports function to plow the soil as the harrow is pulled. As with spring-tine harrows, spike-toothed harrows generally function best on well-cleared land, without irregular contours.

Clay soils also present problems with their inherent clods and hard soil surfaces. Clays are difficult to breakup and convert into a proper seed bed with conventional fillers and harrows. Currently, some cultivator and harrow designs offer the ability to modify the cultivator to suit a range of soil types or harrowing depths, but these modifications can be difficult to make in the field or are ineffective due to the design of the harrow. There is a need for a cultivator better able to prepare substandard soils to give the farmer an ability to cultivate a wider range of soil types. A need also exists for an improved cultivator with more than one specific operational mode.

In a compact disc cultivator, as the frame is pulled forward, for example, by a tractor, the discs engage the ground and revolve, thereby cutting into and scarifying the soil. If the soil is not hard, a disc harrow can be used as both harrow and plow. In order to prevent disc cultivators from cutting too deeply into the soil, disc cultivator frames are commonly vertically adjustable, with regard to their position relative to the ground wheels, allowing the user to control the depth that the cultivator discs cut into the soil. Turning the soil too deeply is not desirable in most situations because the soil dries out by exposing moist underlying soil. This is a significant problem when water is scarce or irrigation expensive. A cultivator is needed, therefore, that dependably tills on the large scale of a modern disc harrow, but without the problem of soil moisture loss.

One method which is used for leveling and smoothing the broken ground after cultivating and to help prevent moisture loss from exposed soil is to gently compact the turned soil with one or more packer rollers. Packing the soil also benefits seed emergence and growth and crop uniformity, increasing overall yields. In order for seeds to germinate, numerous soil conditions must be satisfied, for example, temperature, moisture and porosity of the soil. When conditions are not optimal, packing operations can often be employed to modify water retention and porosity characteristics. Changes in soil porosity affect the soil's ability to transport water, which determines the water uptake for emerging seedlings. Soil packing changes the number and size of the voids, increasing the soil's overall bulk density. As soil moisture generally increases with depth, the water in a layer of compacted soil can only move upward through the seedling depth and toward the soil surface, increasing water availability to seeds and seedlings even in dry seasons.

In addition to increasing the amount of overall moisture in the soil, packing can affect moisture made available to the seed through condensation, in conditions including a large temperature gradient through the depth of the soil to the surface. Other factors which affect germination and emergence include seed type and quality and planting depth.

This soil packing process is conventionally accomplished either as a secondary operation, requiring a second pass by a different implement, or by having one or more packer roller assemblies affixed to the frame behind the harrow discs. With such devices, the frame can be raised to disengage the discs and packer rollers from the ground for transporting the harrow, for example, between fields, or lowered to engage the harrow discs and packer rollers with the ground for working the soil. With this arrangement, though, the packing pressure is directly tied to the harrow disc cutting depth, as the harrow discs and the packer roller assembly are both fixed vertically relative to the frame—as the harrow depth is increased, so is the packing pressure. Alternatively, the packer roller assembly can roll over the ground separately from the frame, with the weight of the packer roller assembly providing the downward force to compact the soil. In this arrangement, the packing pressure cannot be adjusted at all. Accordingly, there is a need for a combination harrow/packer wherein the harrow disc cutting depth and the packing pressure are each individually controllable.

### OBJECT AND SUMMARY OF THE INVENTION

The present invention relates to an agricultural compact disc cultivator having a set of cultivator discs followed by a packer roller, with the disc cutting depth and the packer roller pressure being independently controllable during use.

One object of the present invention provides for a cultivator having a frame to which is attached a plurality of cultivator disc assemblies and a packer roller assembly. In each disc assembly, the cultivator discs are individually and resiliently affixed to a common disc support bar, such that the depth with which the discs bite into the soil can be controlled by raising or lowering the cultivator frame. The packer roller assembly, also attached to the cultivator frame behind the disc assemblies, is independently adjustable relative to the frame, allowing easy and independent control over both the disc assemblies and the packer roller. The invention also relates to a disc cultivator including a set of spring tines for further working the soil subsequent to scarification by the cultivator discs, with the position of the spring tines being independently adjustable relative to the position of the discs and/or the packer roller assembly.

Another object of the present invention is directed to a disc cultivator with a frame adapted to be towed across a field, ground wheels supporting the frame, actuators for changing vertical position of the frame relative to the ground wheels, a cultivator disc assembly attached to the frame, the cultivator disc assembly having rotatable cultivator discs independently suspended from a cultivator disc support bar, a packer roller assembly attached to the frame rearward of the cultivator disc assembly, and actuators for changing vertical position of the packer roller assembly relative to the frame.

A still further object of the present invention is also directed to a disc cultivator having at least one spring tine assembly oriented rearward of the packer roller assembly.

The invention is further directed to a cultivator comprising a frame adapted to be towed across a field; a plurality of ground wheels supporting the frame; actuators adapted to change vertical position of the frame relative to the ground wheels; a cultivator disc assembly attached to the frame, the cultivator disc assembly having a plurality of cultivator discs suspended from a cultivator disc support bar; a packer roller assembly attached to the frame rearward of the cultivator disc assembly; and actuators adapted to change a position of the packer roller assembly relative to the frame.

The present invention is also directed to an agricultural cultivator comprising a set ground wheels; a frame supported on the set of ground wheels; a cultivator disc assembly fixed to the frame; an actuator adapted to move the frame vertically relative to the ground wheels; a hitch on the frame adapted to tow the frame in a horizontal direction; a packer roller assembly pivotally affixed to the frame; and a packer roller actuator adapted to move the packer roller assembly independently relative to the frame and the ground wheels.

The present invention is further directed to a method of operating an agricultural cultivator comprising the steps of providing a set of ground wheels; supporting a frame on the set of ground wheels; affixing a cultivator disc assembly to the frame; permitting an actuator to move the frame vertically relative to the ground wheels; providing a hitch on the frame adapted to tow the frame in a horizontal direction; pivotally affixing a packer roller assembly to the frame; and permitting the packer roller actuator to move the packer roller assembly independently relative to the frame and ground wheels.

These and other features, advantages and improvements according to this invention will be better understood by reference to the following detailed description and accompanying drawings.

### BRIEF DESCRIPTION OF THE DRAWINGS

Several embodiments of the present invention will now be described by way of example only, with reference to the accompanying drawings in which:

FIG. 1 is a side elevation view of the disc cultivator of the invention with the frame and packer roller assemblies raised;

FIG. 2 is a side elevation view showing the frame and packer roller assemblies lowered for use;

FIG. 3 is a top planar view of a “folding wing” embodiment of the invention with the wing sections spread for use;

FIG. 4 is a perspective view of the disc cultivator of FIG. 3 with the “wing” sections spread for use;

FIG. 5 is a front elevation view of the disc cultivator of the invention with the frame and packer roller assemblies raised;

FIG. 6 is a rear elevation view of the disc cultivator of the invention with the frame and packer roller assemblies raised;

FIG. 7 is a perspective view of the embodiment of the present invention shown in FIG. 4 with the “wing” sections folded into a traveling configuration for transportation;

FIG. 8 is a front elevation view of the embodiment of the present invention shown in FIG. 4 with the “wing” sections folded and the frame and packer roller assemblies raised for transportation;

FIG. 9 is a side elevation view of the embodiment of the present invention shown in FIG. 4 with the “wing” sections folded and the frame and packer roller assemblies raised for transportation;

FIG. 10 is a perspective view of a rigid hitch embodiment of the present invention;

FIG. 11 is a perspective view of the rigid hitch embodiment of the present invention with the “wing” sections folded into a traveling configuration for transportation;

FIG. 12 is a top plan view of the rigid hitch embodiment of the present invention;

FIG. 13 is a side elevation view of the rigid hitch embodiment having packer roller lowered and engaged with ground surface; and

FIG. 14 is a side elevation view of the rigid hitch embodiment having packer roller raised and disengaged with ground surface.

### PARTS LIST

10 Disc Cultivator
12 rectangular frame
14 tow bar
16 first set of ground wheels
18 articulated joint
20 first hydraulic actuator
22 cultivator disc assembly
24 cultivator discs
25 disc arm
26 cultivator disc support bar
28 second set of ground wheels
30 second hydraulic actuator
32 packer roller gang assembly
33 parallel linkage
34 third hydraulic actuator
35 roller support bar
36 central frame portion
38 left-wing side frame portion
39 right-wing side frame portion
40 center frame portion
42 left wing actuator
44 right wing actuator
51 floating hitch pivot point
53 rigid hitch connection

### DETAILED DESCRIPTION OF THE INVENTION

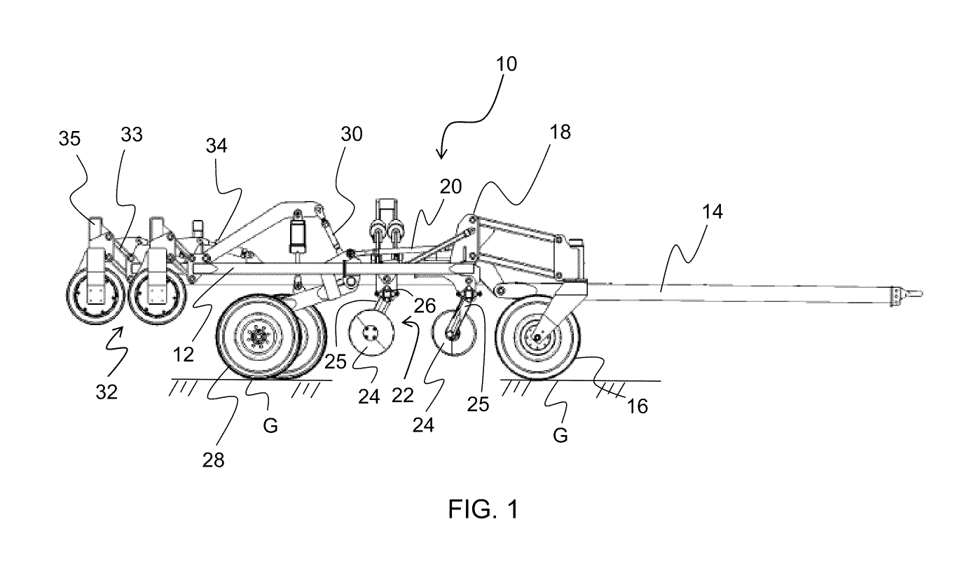

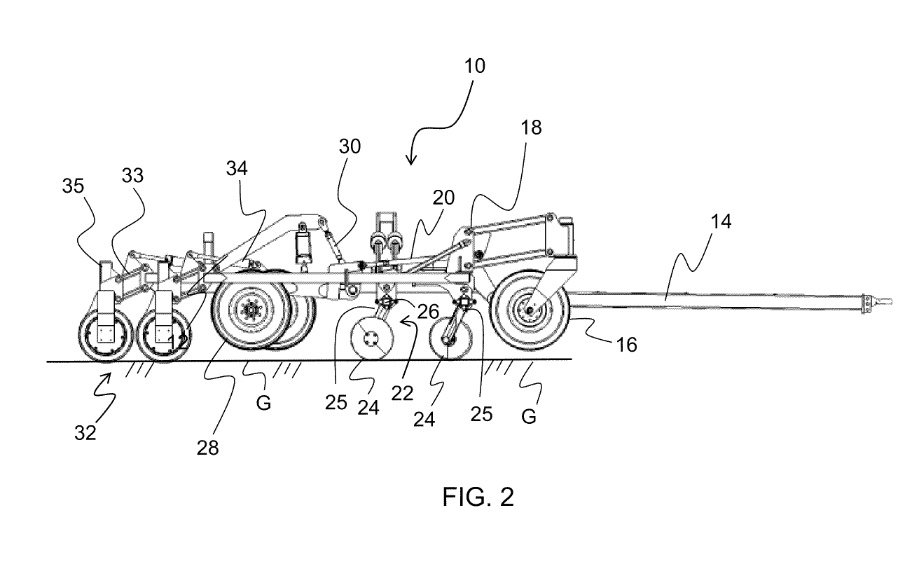

FIGS. 1 and 2 are side views of the present invention with FIG. 1 being a raised, traveling state of the disc cultivator 10 and FIG. 2 being a lowered, in use state of the disc cultivator 10. The disc cultivator 10 is shown having a generally rectangular frame 12 adapted to be towed across a field. A tow bar 14 is attached to a forward end of the frame 12 and a first set 16 of ground wheels extends forward of the frame 12. An articulated joint 18 connects each of the first set 16 of ground wheels to the frame and the articulated joint 18 allows relative vertical displacement between the frame 12 and the ground wheels 16. A first hydraulic actuator 20 is adapted to adjust and maintain relative vertical displacement between the first set 16 of ground wheels and the frame 12. A plurality of cultivator disc assemblies 22 are attached to the frame 12 rearward of the first set 16 of ground wheels with each disc assembly 22 having a plurality of rotatable cultivator discs 24 supported by a disc arm 25 independently suspended from a cultivator disc support bar 26. A second set of ground wheels 28 are pivotally attached to the frame 12 rearward of the plurality of disc gang assemblies 22 and a second hydraulic actuator 30 is adapted to adjust and maintain relative vertical position between the second set 28 of ground wheels and the frame 12. A packer roller gang assembly 32 is attached to the frame 12 rearward of the second set 28 of ground wheels and a third hydraulic actuator 34 is adapted to adjust and maintain relative vertical position between the packer roller gang assembly 32 and the frame 12.

The position of the frame 12 relative to the ground wheels 16, 28, and correspondingly, to the ground, can be adjusted during use by the user by means of first and second hydraulic actuators 20, 30. Preferably, the first and second hydraulic actuators 20, 30 work in concert in order to maintain the frame 12 in a generally horizontal orientation. Alternatively, conditions may favor a non-horizontal frame orientation, in such a case the first and second hydraulic actuators 20, 30 work in concert to maintain the frame in a non-horizontal orientation. As shown in FIG. 1, when the user lowers the first and second hydraulic actuators 20, 30 causing the respective ground wheels 16, 28 to be in contact with a ground surface G, the packer roller gang assembly 32 is raised off the ground as it is attached to the frame 12 rearward of the second set 28 of ground wheels and the cultivator discs 24 are similarly raised out of contact with the ground G where they are situated between the first and second set of ground wheels 16, 28. As seen in FIG. 2, here the ground wheels 16, 28 are raised up by the respective hydraulics 20, 34 and the cultivator discs 24 are able to cut into the ground surface G and soil and the packer roller gang assembly 32 is in contact with the ground surface G as well.

With regard to the packer roller gang assembly 32, there are numerous suitable shapes and sizes of agricultural packers. The physical characteristics of the packer 32 manifest themselves as a compaction effect on the soil to control soil moisture content through condensation, reducing evaporation and increasing available soil moisture to seeds planted or which will be planted. A variety of characteristics make each type of packer unique: static weight, dynamic packing force, wheel diameter, spacing, soil disturbance, velocity of travel, pulverization of aggregates and compaction effort are all factors which must be examined when determining the benefits of one packing implement over another. Typical types of packers include coil, cylinder, ganged, single packer rollers, tandem packer rollers, toothed and smooth. Each type can be suitably employed with the present invention.

As illustrated in FIGS. 1 and 2, the depth with which the cultivator discs 24 dig into the soil can be controlled by raising and lowering the frame 12 relative to the ground wheels 16, 28. If the wheels are raised completely off the ground G as in FIG. 2, the discs 24 will dig into the ground to an extent based on the soil type and density and the weight of the cultivator 10, cultivator speed, disc alignment etc.

The cultivator of the present invention can be used in several distinct orientations, in addition to providing fine, on-the-fly adjustment of cultivator depth and packing pressure. FIG. 1 illustrates an orientation with the frame 12 raised such that the cultivator discs 24 do not contact the soil, and with the packer roller assembly 32, shown as a tandem packer roller, also raised above the ground surface. This orientation is generally used for transporting the cultivator between fields. FIG. 2 illustrates an orientation wherein the frame 12 has been lowered relative to the ground wheels 16, 28, such that the cultivator discs 24 dig into and work the soil surface. To work the surface more deeply, the frame 12 can be further lowered by means of the first 20 and second 30 hydraulic actuators raising the wheels 16, 28 relative to the frame and the ground G. To work the soil less deeply, the frame 12, and hence the discs 24, can likewise be raised by lowering the ground wheels 16, 28 into contact with the ground surface G such that the frame and discs 24 are raised relative to the ground surface G.

An important aspect of the present invention is that the adjustment and positioning of the packer roller assembly 32 on a rear portion of the frame 12 is controllable independently from the cultivator discs 24 as well as independently from the wheels 16, 28 and frame 12. A parallel linkage 33 adjustably connects a roller support bar 35 to the rear portion of the frame 12 so that a hydraulic roller actuator 34 can raise and lower the entire packer roller assembly 32 relative to the frame 12 and the ground surface G about a set of pivot points defined by the parallel linkage 33 connection between the frame 12 and the roller support bar 35. As seen by the relative arrangements shown in FIGS. 1 and 2, through this structure and actuator 34 the packer roller assembly 32 can be brought into varied contact pressures with the ground surface to facilitate and improve working and the preparation of the soil for planting and growing.

As seen in FIG. 2 the disc cultivator 10 includes the packer roller assembly 32 being lowered, by means of the third hydraulic actuator 34, in order to engage and compact the ground surface. The pressure with which the packer roller assembly 32 packs the soil surface can thus be remotely adjusted at any point in time or during use by an operator by actuation of the third hydraulic actuator 34. For example the soil may have a minimal amount of water content so that a light application of roller pressure is provided to lightly compact the surface to reduce exposed surface area of the soil and maintain the water in the soil as opposed to exposing the water to the air where the soil is uncompacted and presents more soil particles exposed to the atmosphere. Without the ability to vary the packer roller pressure in the manner described herein, the soil can become over compacted in such an environment.

Alternatively, because of the independent control of the packer roller 32, the present invention can be employed solely as a disc cultivator, that is, in an orientation including the frame 12 lowered so that the cultivator discs scarify the soil and work the ground while the packer roller assembly 32 is raised above the ground so that the ground is not compacted at all. The present invention can also be employed solely as a packer roller, with the packer roller assembly 32 lowered to compact the ground and the frame raised so that the cultivator discs do not engage the soil.

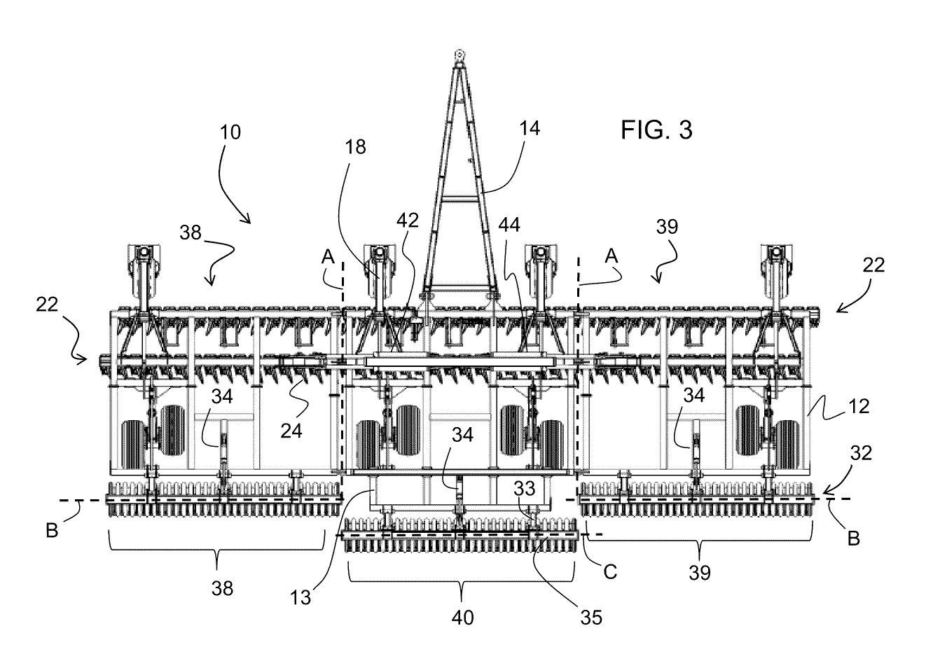

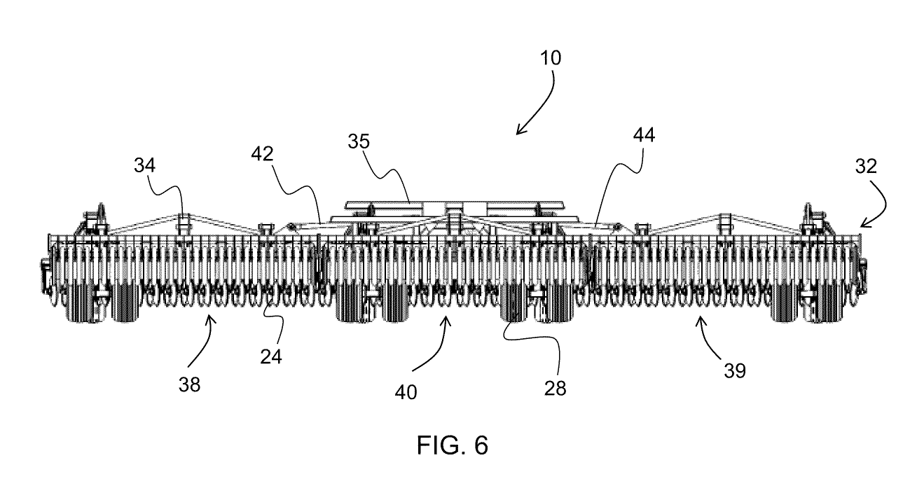

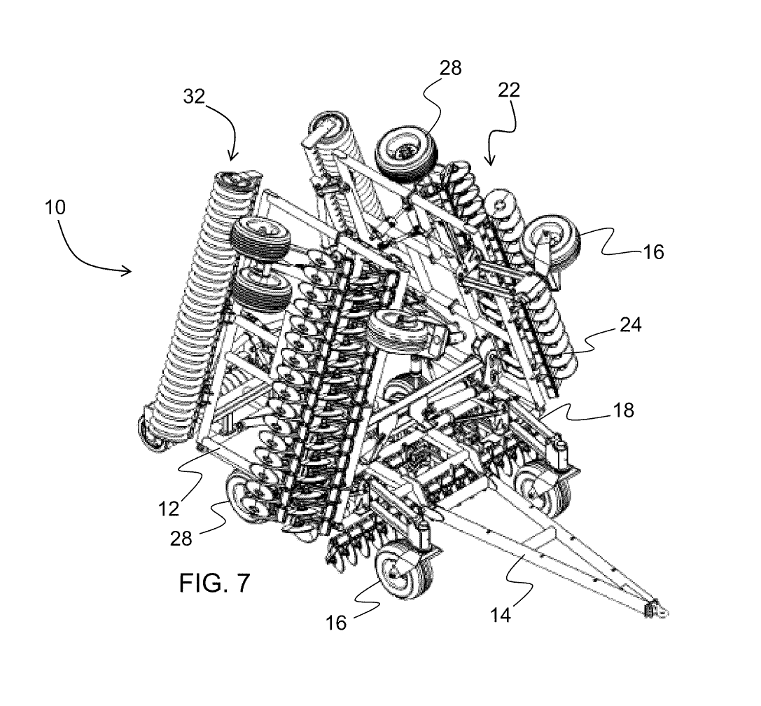

The plan view of FIG. 3 details the structural arrangement of the disc cultivator 10 having the packer rollers 32 trailing entirely rearward of the wheels 16, 28 so that any tread or wheel marks are eliminated by soil compaction from the packer roller assembly 32 and a uniform packing pressure is provided to the soil. In the structural arrangement shown in the present embodiment, the disc cultivator 10 includes three separate, but hinged together frames, a left-wing 38, a right-wing 39 and a center portion 40. The left and right wings 38, 39 are hingedly attached to the opposing sides of center portion 40 along axes A such that a respective left and right wing actuators 42, 44 can be used to raise the left and right wings 38, 39 about the hinged attachment to the center portion 40 between a traveling configuration as shown in FIG. 7 and the working position as shown in FIGS. 1-6.

Still observing FIG. 3, it is to be appreciated that the packer roller 32 of the center portion 40 of the disc cultivator 10 extends a greater distance rearward of the frame 12, by a rear frame extension 13, as opposed to the packer rollers 32 on the left and right wings 38, 39. In other words the center axes B of the left and right wing rollers are radially displaced from, but parallel with the center axis C of the center portion 40 roller. This arrangement permits at least a close alignment or even slight axial overlap between the adjacent packer rollers 32 to ensure that substantially all the soil underneath over which the disc cultivator 10 passes can be uniformly compacted.

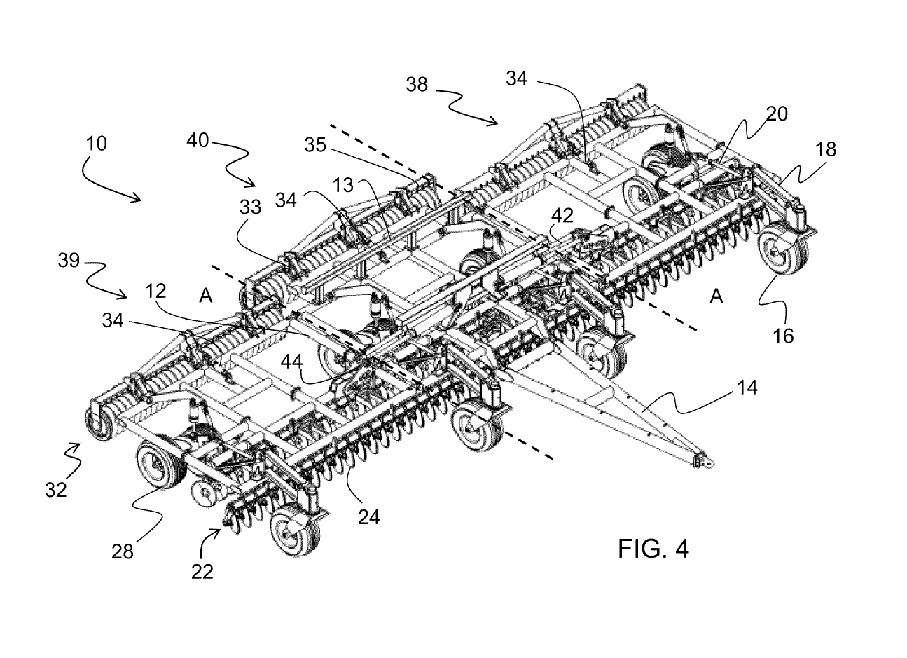

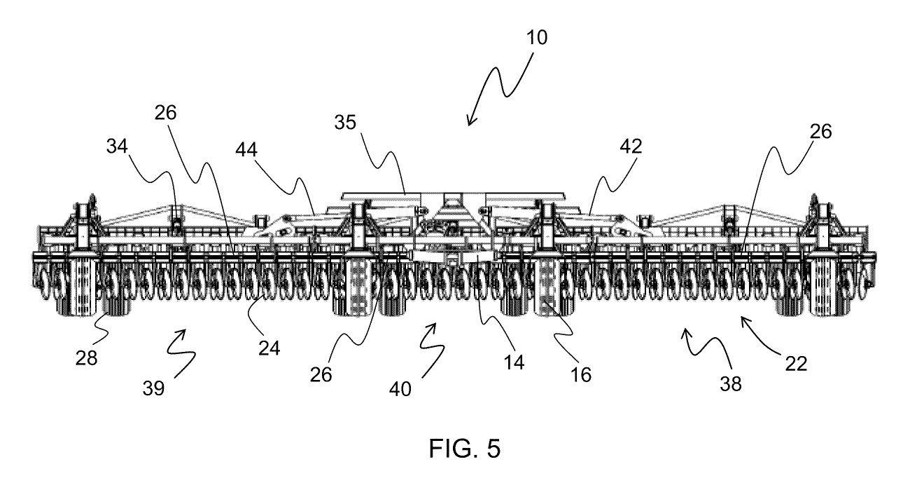

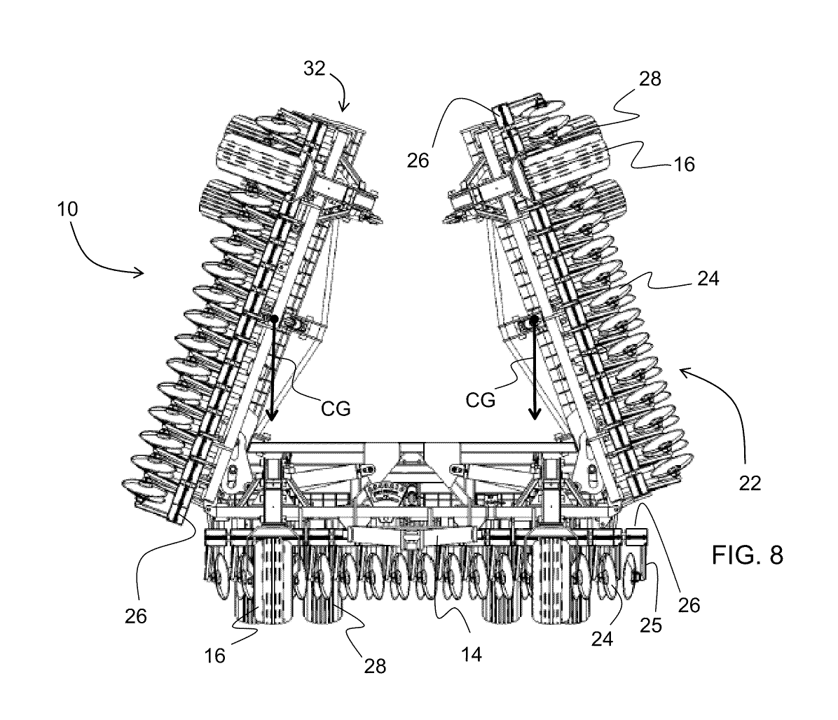

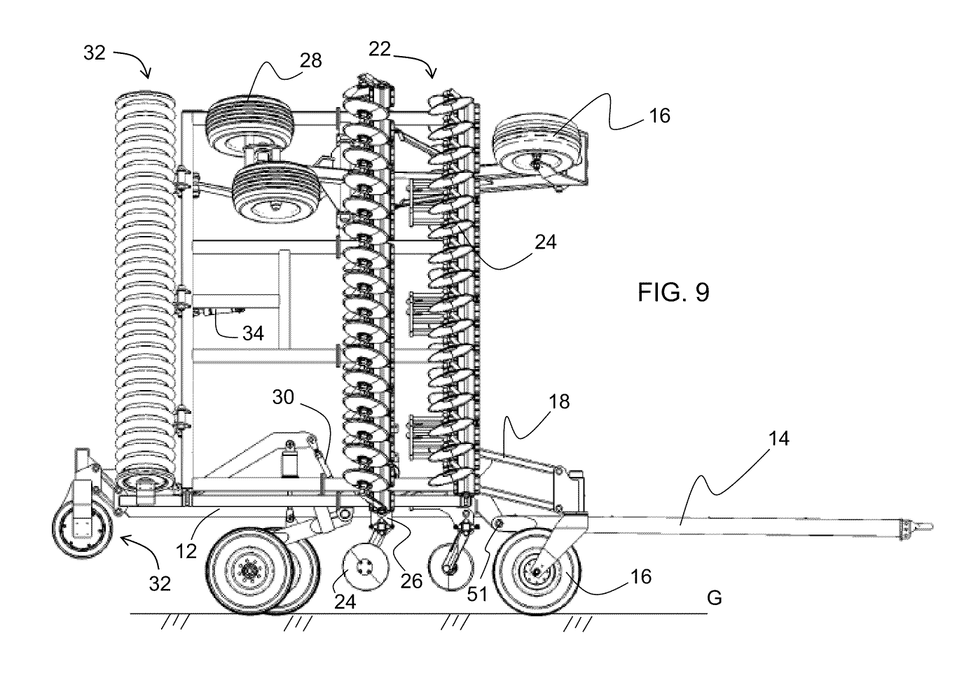

As best seen in FIGS. 4 and 5, each of the left and right wing hydraulic actuators 42, 44 are in this embodiment a double actuator set used to raise and lower each respective wing. Each of the hydraulic actuators 42, 44 are attached at a first end to a point on the center portion 40 of the cultivator 10, and a second end of each actuator 42, 44 is attached a point on the respective left and right wings 38, 39 of the cultivator 10. The wing hydraulic actuators 42, 44 impart the necessary force to rotate the left and right wings 38 and 39 about the axes A with the center portion 40. When the hydraulic wing actuators 42, 44 are activated by the operator, for instance to place the disc cultivator 10 into the travel position the actuators 42, 44 retract and pull up each of the left and right wings 38, 39 such that the wings 38, 39 pivot about the wing axes A until the wings 38, 39 are brought into A-frame alignment as shown in FIGS. 7-9. This A-frame alignment facilitates travel of the cultivator 10 behind a tractor or other vehicle because the center of gravity CG of these wings 38, 39 is within the width of the center portion. This arrangement is important so that stability of the disc cultivator 10 during transportation is maintained with the wing center of a gravity CG, being balanced and as close to the middle of the center portion 40 as possible.

When in the working position with the wings 38, 39 positioned downwards in contact with the ground surface G, in order to function efficiently over uneven surfaces, and to avoid damaging the discs 24 if rocks or hard objects are encountered during use, the cultivator discs 24 are individually and resiliently affixed to the cultivator disc support bars 26. The discs 24 and support arms 25 make up a disc assembly 22. In the embodiment illustrated in the drawings, the plurality of cultivator disc assemblies 22 provided are generally parallel with each other and supported on the support bar 26. The disc assemblies 22 may be rigidly attached to the support bar 26, or may be provided with flexible, shock absorbing structures such as elastic or spring type shock absorbers to give the assemblies an amount of flexibility in the event of a rock strike.

Additionally, the disc cultivator 10 can include at least one spring tine assembly (not shown in drawings) rearward of the packer roller assembly 32 for further treating the ground surface subsequent to packing. Compacting soil can sometimes be improved by treating the soil following compaction. While an effective barrier to evaporation is desired, packing can result in “crusty” surfaces which can be an impediment to seedling emergence. The spring tine assembly lightly scarifies the soil surface, leaving a layer of loose soil above the seed layer and the compacted soil. In a preferred embodiment of the invention, the depth with which the spring tine assembly engages the ground is also independently controllable, for example, with a hydraulic actuator.

In the above described embodiment a floating hitch is utilized to connect the tow bar 14 to the cultivator. Floating hitches permit more articulation in situations where the terrain being tilled is undulating or more contoured. A single set of castor wheels 28 support the frame 12 and/or the packer roller assembly 32 rearward of the frame 12. The floating hitch consists generally of a pivot point 51 at the connection of the tow bar 14 to the frame 12 which permits the cultivator frame to rotate or pivot about pivot point 51 relative to both the tow bar 14 and the tractor. Such a floating hitch facilitates the main frame 12 of the cultivator remaining substantially level with the terrain over which it is traveling so that a uniform cutting and tillage depth is maintained while the tractor and hitch seek their own level conditions.

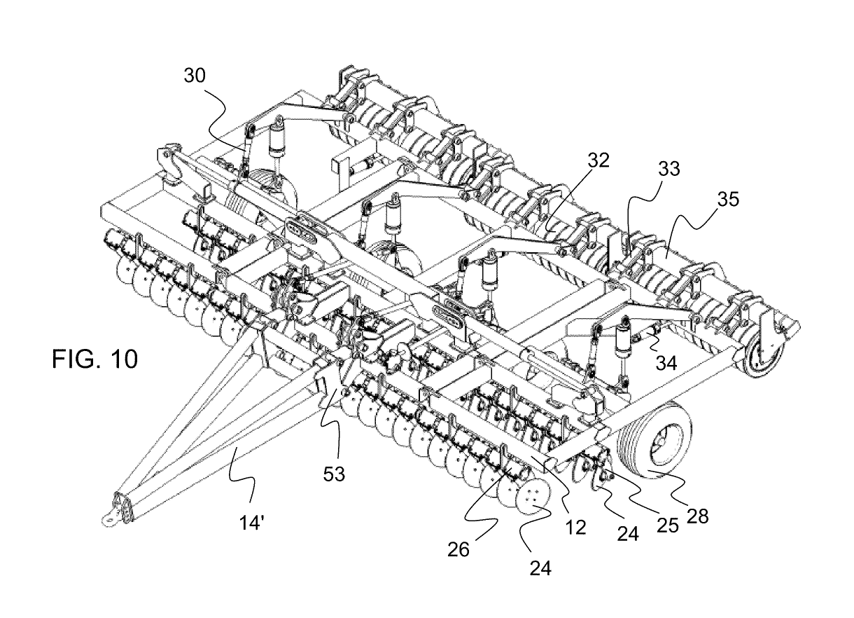

In another embodiment of the invention a rigid hitch may be used where flatter terrain is considered. The rigid hitch does not need the front castor wheel set 16 as shown in FIG. 10 because the front of the cultivator is supported by a rigid connection with the tow bar 14′. The tow bar 14′ has a substantially rigid connection with the frame 12 at the connection point 53. Because of the rigid connection point 53 the castor wheel set 16 are not necessary as the front of the frame 12 is supported by the tow bar 14′ and the tractor.

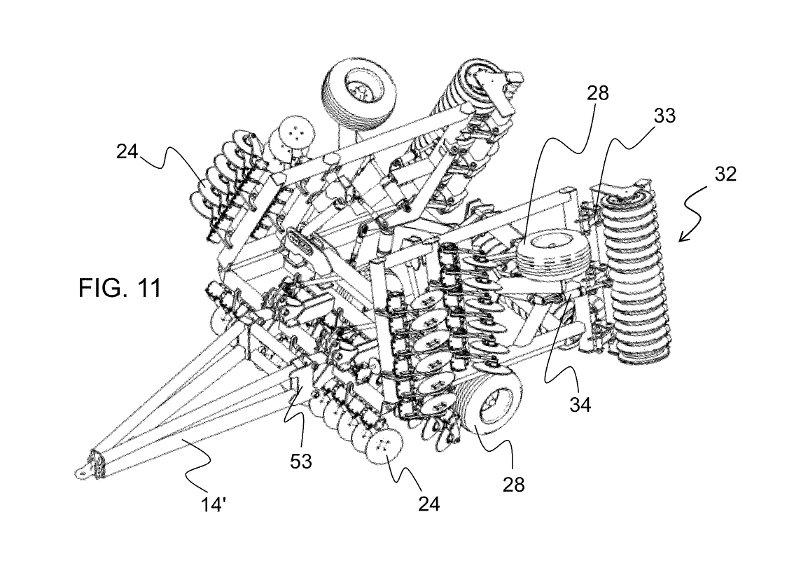

In this rigid hitch embodiment the frame 12 and cultivator tends to travel more directly with the tractor rather than with the topography of the terrain. This tends to lead to better handling during travel states where the cultivator is not cutting but merely transported from place to place. As in the prior embodiment the adjustment and positioning of the packer roller assembly 32 on a rear portion of the frame 12 is controllable independently from the cultivator discs 24 as well as independently from the wheels 28 and frame 12. A parallel linkage 33 adjustably connects the roller support bar 35 to the rear portion of the frame 12 so that a hydraulic roller actuator 34 can raise and lower the entire packer roller assembly 32 relative to the frame 12 and the ground surface G about a set of pivot points defined by the parallel linkage 33 connection between the frame 12 and the roller support bar 35. As seen by the relative arrangements shown in FIGS. 10-11, the actuators 34 in this embodiment are connected on an underside surface of the frame 12. Through this structure and actuator 34 the packer roller assembly 32 can be brought into varied contact pressures with the ground surface to facilitate and improve working and preparation of the soil for planting and growing.

The pressure with which the packer roller assembly 32 packs the soil surface can thus be remotely and independently adjusted relative to the cutting depth of the discs at any point in time or during use by an operator by actuation of the third hydraulic actuator(s) 34. For example the soil may have a minimal amount of water content so that a light application of roller pressure is provided to lightly compact the surface to reduce exposed surface area of the soil and maintain the water in the soil as opposed to exposing the water to the air where the soil is uncompacted and presents more soil particles exposed to the atmosphere. The compaction is done without regard to the depth of the cutting discs or the relative wheel and frame height. Without the ability to vary the packer roller pressure in the independent manner described herein, the soil can become over compacted in such an environment.

Alternatively, because of the independent control of the packer roller 32, the present invention can be employed solely as a disc cultivator, that is, in an orientation including the frame 12 lowered so that the cultivator discs 24 scarify the soil and work the ground while the packer roller assembly 32 is raised above the ground so that the ground is not compacted at all. The present invention can also be employed solely as a packer roller, with the packer roller assembly 32 lowered to compact the ground and the frame raised so that the cultivator discs 24 do not engage the soil.

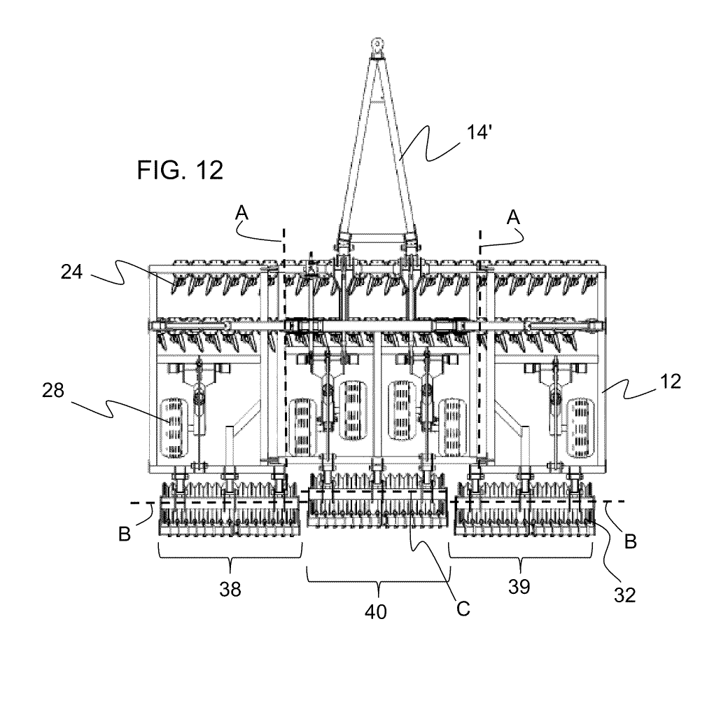

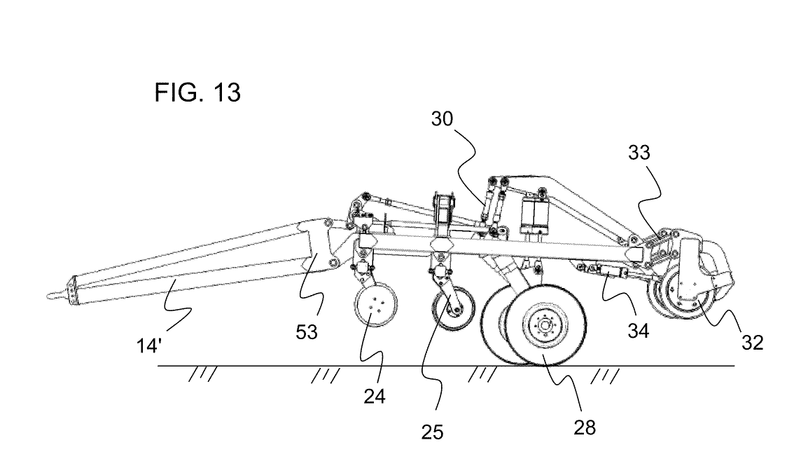

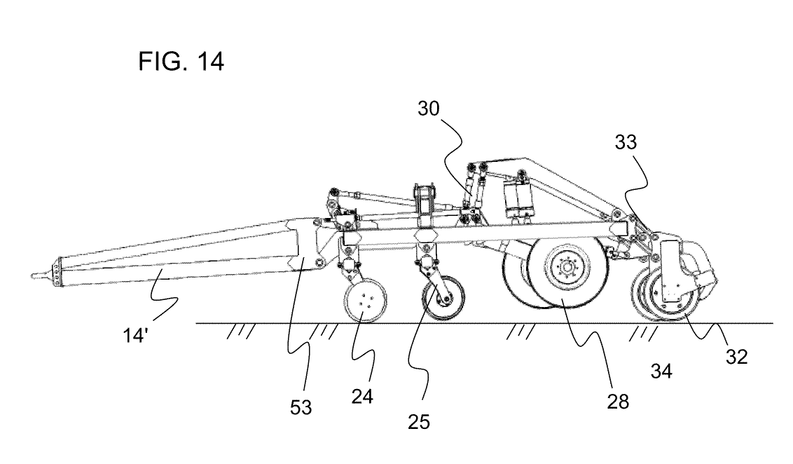

The top plane view of FIG. 12 details the structural arrangement of the disc cultivator 10 having the packer rollers 32 trailing entirely rearward of the wheels 28 so that any tread or wheel marks are eliminated by soil compaction from the packer roller assembly 32 and a uniform packing pressure is provided to the soil. In the structural arrangement shown in the present embodiment, the disc cultivator 10 includes three separate, but hinged together frames, a left-wing 38, a right-wing 39 and a center portion 40. The left and right wings 38, 39 are hingedly attached to the opposing sides of center portion 40 along axes A such that a respective left and right wing actuators 42, 44 can be used to raise the left and right wings 38, 39 about the hinged attachment to the center portion 40 between a traveling configuration as shown in FIG. 13 and the working position as shown in FIG. 14.

FIGS. 13-14 detail the independent articulation of the packer roller assembly 32 about the parallel linkage 33 which adjustably connects the roller support bar 35 to the rear portion of the frame 12 so that a hydraulic roller actuator 34 can raise and lower the entire packer roller assembly 32 relative to the frame 12 and the ground surface G about a set of pivot points defined by the parallel linkage 33 connection between the frame 12 and the roller support bar 35. It is to be appreciated that because of the independent articulation of the packer roller 32, the depth of the discs can be determined entirely by the raising and lowering of the main wheels 28, or alternatively as in FIG. 13 the packer roller may also effect the depth. The critical importance of the independent articulation of the packer roller is that no matter what depth the discs 24 are cutting, and consequently whatever the level of the frame 12 is to the ground, the packer roller assembly 32 can be adjusted to provide very light compaction of the tilled soil, or a heavier compaction. It may be that a heavier compaction could cause elevation variances of the discs and frame as shown in FIG. 14, however the ability to adjust such roller pressure and disc depth independently provides an improved tillage characteristics and abilities to the cultivator.

The invention has been described in detail with particular reference to certain preferred embodiments thereof, but it will be understood that variations and modifications can be effected within the spirit and scope of the invention.

1. A cultivator comprising:
a frame adapted to be towed across a field;
a plurality of ground wheels supporting the frame;
actuators adapted to change vertical position of the frame relative to the ground wheels;
a cultivator disc assembly attached to the frame, the cultivator disc assembly having a plurality of cultivator discs suspended from a cultivator disc support bar;
a packer roller assembly having adjustable parallel linkage for attachment to the frame rearward of the cultivator disc assembly;
actuators adapted to change a position of the packer roller assembly relative to the frame; and
wherein the plurality of ground wheels further comprises a first set of ground wheels positioned forward of the cultivator disc assembly and a second set of ground wheels attached to the frame rearward of the cultivator disc assembly to facilitate an operator controlled orientation of the frame and cultivator discs relative to the field.

2. The cultivator according to claim 1, wherein the actuator for changing vertical position of the frame relative to the ground wheels comprises one or more hydraulic frame actuators.

3. The cultivator according to claim 2, wherein the actuator for changing vertical position of the packer roller assembly relative to the frame comprises one or more hydraulic actuators operated independently of the frame actuators.

4. The cultivator according to claim 3, further comprising at least one spring tine assembly rearward of the packer roller assembly.

5. An agricultural cultivator comprising:
a first and second set of ground wheels;
a frame supported on the set of ground wheels;
a cultivator disc assembly fixed to the frame;
first and second hydraulic actuators adapted to move the frame vertically relative to the ground wheels;
a hitch on the frame adapted to tow the frame in a horizontal direction;
a packer roller assembly pivotally affixed to the frame using an adjustable parallel linkage;
a packer roller actuator adapted to move the packer roller assembly independently relative to the frame and the ground wheels; and
wherein the first set of ground wheels is positioned forward of the cultivator disc assembly and the second set of ground wheels is attached to the frame rearward of the cultivator disc assembly to facilitate an operator controlled orientation of the frame and cultivator discs relative to the field.

6. The cultivator according to claim 5, further comprising an articulated joint connecting a tow bar to the frame such that the frame is vertically movable relative to the tow bar.

7. The cultivator according to claim 5 wherein the cultivator discs are resiliently affixed to a plurality of disc gang assemblies.

8. The cultivator according to claim 7 wherein the plurality of disc gang assemblies is generally parallel with each other.

9. The cultivator according to claim 5, further comprising a three part folding wing orientation.

10. The cultivator according to claim 5 wherein a third hydraulic actuator operates the packer roller assembly independently of first and second hydraulic actuators.

11. The cultivator according to claim 5, further comprising a second packer roller gang assembly adjacent the packer roller gang assembly.

12. The cultivator according to claim 5, wherein the packer roller gang assembly is generally perpendicular to direction of movement.

13. The cultivator according to claim 7, wherein the plurality of disc gang assemblies is generally perpendicular to direction of movement.

14. The cultivator according to claim 5, wherein the first and second hydraulic actuators are cooperatively controlled.

15. The cultivator according to claim 14, wherein the first and second hydraulic actuators are cooperatively controlled to maintain the frame in a generally horizontal orientation.

16. The cultivator according to claim 7 wherein the cultivator discs are resiliently affixed to the plurality of disc gang assemblies.

17. The cultivator according to claim 16 wherein the plurality of disc gang assemblies is generally parallel with each other.

18. The cultivator according to claim 17, further comprising a three part folding wing orientation.

19. A method of operating an agricultural cultivator comprising the steps of:
providing a first and second set of ground wheels;
supporting a frame on the set of ground wheels;
affixing a cultivator disc assembly to the frame;
permitting an actuator to move the frame vertically relative to the ground wheels;
providing a hitch on the frame adapted to tow the frame in a horizontal direction;
pivotally affixing a packer roller assembly to the frame using an adjustable parallel linkage; and
permitting the packer roller actuator to move the packer roller assembly independently relative to the frame and ground wheels; and
positioning the first set of ground wheels forward of the cultivator disc assembly and the second set of ground wheels are attached to the frame rearward of the cultivator disc assembly to facilitate an operator controlled orientation of the frame and cultivator discs relative to a ground surface.
